(19) United States
(12) Patent Application Publication
(10) Pub. No.: US 2012/0218384 A1
(43) Pub. Date: Aug. 30, 2012

(54) IMAGE SIGNAL PROCESSING MODE SWITCHING APPARATUS AND IMAGE SIGNAL PROCESSING MODE SWITCHING METHOD

(75) Inventor: Go Tomita, Fukaya-shi (JP)

(73) Assignee: KABUSHIKI KAISHA TOSHIBA, Tokyo (JP)

(21) Appl. No.: 13/308,258

(22) Filed: Nov. 30, 2011

(30) Foreign Application Priority Data
Feb. 25, 2011 (JP) 2011-040472

(51) Int. Cl. H04N 13/00

(52) U.S. Cl. 348/43; 348/E13.062

(57) ABSTRACT

According to one embodiment, a decoder outputs a decoded image signal by decoding an encoded image signal in accordance with additional data. A signal processor processes the decoded image signal in a 2D image signal processing mode or a 3D image signal processing mode. A first detector detects whether a specific picture frame of the encoded image signal has been decoded. A second detector analyzes the additional data, detecting whether the encoded image signal pertains to 2D or 3D. When the first detector detects that the specific picture frame has been decoded, the second detector outputs the result of detection to a signal processing mode switch provided in the signal processor.

### CROSS-REFERENCE TO RELATED APPLICATIONS

This application is based upon and claims the benefit of priority from prior Japanese Patent Application No. 2011-040472, filed Feb. 25, 2011, the entire contents of which are incorporated herein by reference.

### FIELD

Embodiments described herein relate generally to an image signal processing mode switching apparatus and an image signal processing mode switching method.

### BACKGROUND

Recently, stereoscopic displays have been sold as products in the field of television technology. Further, the broadcasting of stereoscopic image signals (hereinafter called “3D image signals”) has come into practice. The broadcasting of two-dimensional image signals (hereinafter called “2D image signals”) is also in service. Hence, 2D image signals and 3D image signals may be broadcast, while being switched at random. (Hereinafter, these image signals so broadcast will be referred to as “2D/3D mixed broadcast signals.”)

When a 2D/3D mixed broadcast signal is switched from a 2D image signal to a 3D image signal or from a 3D image signal to a 2D image signal, a user at any receiver determines whether the receiver is receiving a 2D image signal or a 3D image signal, from the image being displayed on the screen. The user then manually operates the receiver, switching the signal processing mode of the receiver, from the 2D image signal processing mode to the 3D image signal processing mode, or from the 3D image signal processing mode to the 2D image signal processing mode.

In the broadcasting apparatus, an identification signal may be added, to each broadcast image signal, as additional data that shows whether the signal is a 2D image signal or a 3D image signal. In the receiver, the identification signal is detected, and the signal processing mode is automatically switched in accordance with the identification signal.

If the signal processing mode is automatically switched in the receiver, however, new problems may arise.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a diagram schematically showing a stereoscopic video display apparatus related to an embodiment;

FIG. 2 is a diagram showing the overall configuration of a television broadcast receiver that incorporates an image signal processing mode switching apparatus;

FIG. 3 is a diagram showing a representative basic configuration for the image signal processing mode switching apparatus;

FIG. 4 is a diagram showing another representative basic configuration for the image signal processing mode switching apparatus;

FIG. 5 is a timing chart showing how the apparatus according to the embodiment operates to switch the 3D image signal processing mode to the 2D image signal processing mode;

FIG. 6 is a flowchart showing how the apparatus operates at such timing as shown in FIG. 5;

FIG. 7 is a timing chart showing how the apparatus according to the embodiment operates to switch the 2D image signal processing mode to the 3D image signal processing mode; and

FIG. 8 is a flowchart showing another manner in which the apparatus according to the embodiment may operate.

### DETAILED DESCRIPTION

Various embodiments will be described hereinafter with reference to the accompanying drawings.

In general, according to one embodiment, there are provided an apparatus and method for switching an image signal processing mode which can cope with new problems that may arise when the signal processing mode is automatically switched in accordance with the state in which a 2D/3D mixed broadcast signal is received.

Further, there are provided an apparatus and method for switching an image signal processing mode, in which no excessive load is imposed on the control block of a receiving apparatus, the signal processing mode can be appropriately switched as fast as possible, errors are prevented in switching the signal processing mode, and the noise made at the display unit is reduced at the time of switching the image signal processing mode.

According to an embodiment of the present disclosure, a decoder outputs a decoded image signal by decoding an encoded image signal in accordance with additional data. A signal processor processes the decoded image signal in a 2D image signal processing mode or a 3D image signal processing mode. A first detector detects whether a specific picture frame of the encoded image signal has been decoded. The second detector analyzes the additional data, detecting whether the encoded image signal pertains to 2D or 3D. When the first detector detects that the specific picture frame has been decoded, the second detector supplies the result of detection to a signal processing mode switch provided in the signal processor.

An embodiment will further be described with reference to the drawings.

At first, a stereoscopic video display apparatus will be described.

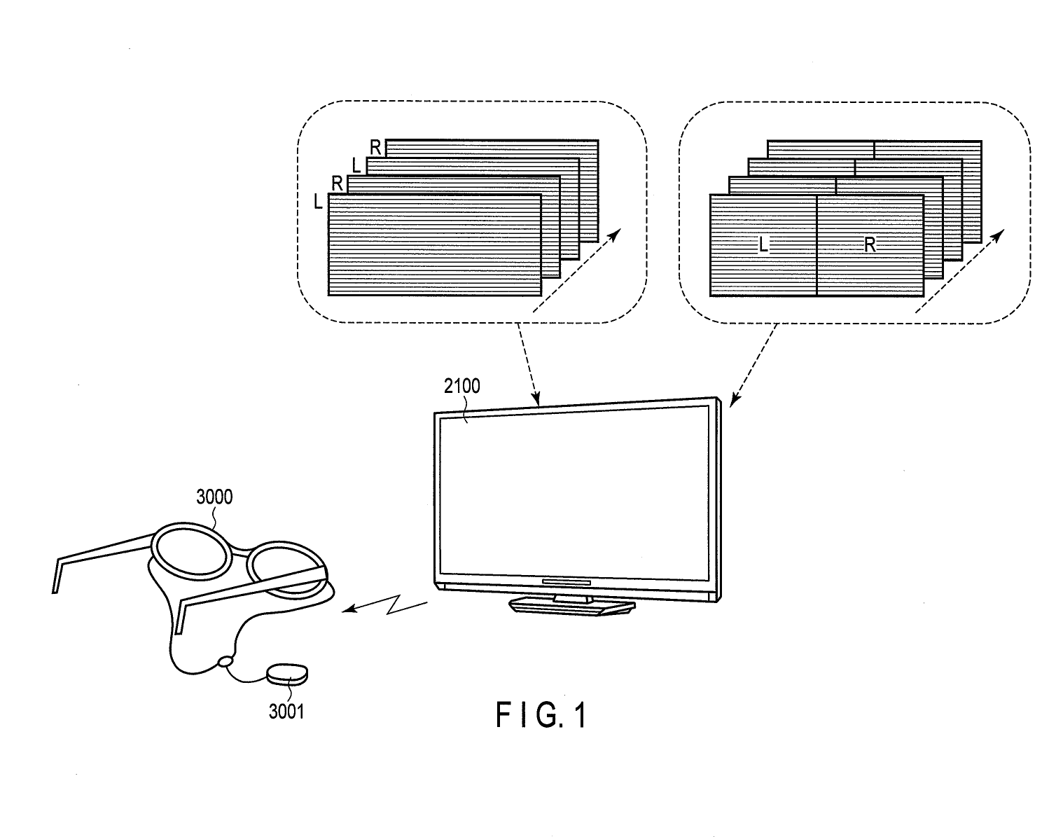

FIG. 1 is an example of a stereoscopic video display apparatus of the twin type in which stereoscopic video can be observed by using glasses, in FIG. 1, two twin types are shown simultaneously.

The first type is an example in which a left eye video (L) and a right eye video (R) are alternately displayed for each frame in a TV set 2100. A signal of the left eye video (L) and a signal of the right eye video (R) may be either sent from outside or generated as a dummy signal from a 2D display video signal inside the TV set.

Identification information indicating which of the left eye video and the right eye video is the currently displayed video is output from the TV set 2100. A transfer medium of left/right identification information may be a wire, radio wave, or infrared ray. 3D glasses 3000 have a receiver 3001, which receives identification information and controls a shutter operation of left and right liquid crystal glasses to synchronize the shutter operation to the displayed left/right video. Accordingly, a viewer can perceive stereoscopic video by observing the right eye video with the right eye and the left eye video with the left eye.

The second type is an example in which the left eye video (L) arranged in a left half of a frame and the right eye video (R) arranged in a right half of the frame are displayed in the TV set 2100. Also, a signal of the left eye video (L) and a signal of the right eye video (R) may be either sent from outside or generated as a dummy signal from a 2D display video signal inside the TV set. This method may be called a side-by-side method. Outgoing light by left video and outgoing light by right video are different in polarization direction and polarizing glasses are used as the 3D glasses 3000. Left and right glasses have polarization properties, the left glass allows the left video to pass, and the right glass allows the right video to pass. Accordingly, the viewer can perceive stereoscopic video by observing the right eye video with the right eye and the left eye video with the left eye. A shatter operation of a left liquid crystal grass and right liquid crystal grass of the 3D glasses 3000 may be synchronized with left and right image displayed on the screen under the control.

Further, various other stereoscopic video display methods are known, but a description thereof is omitted.

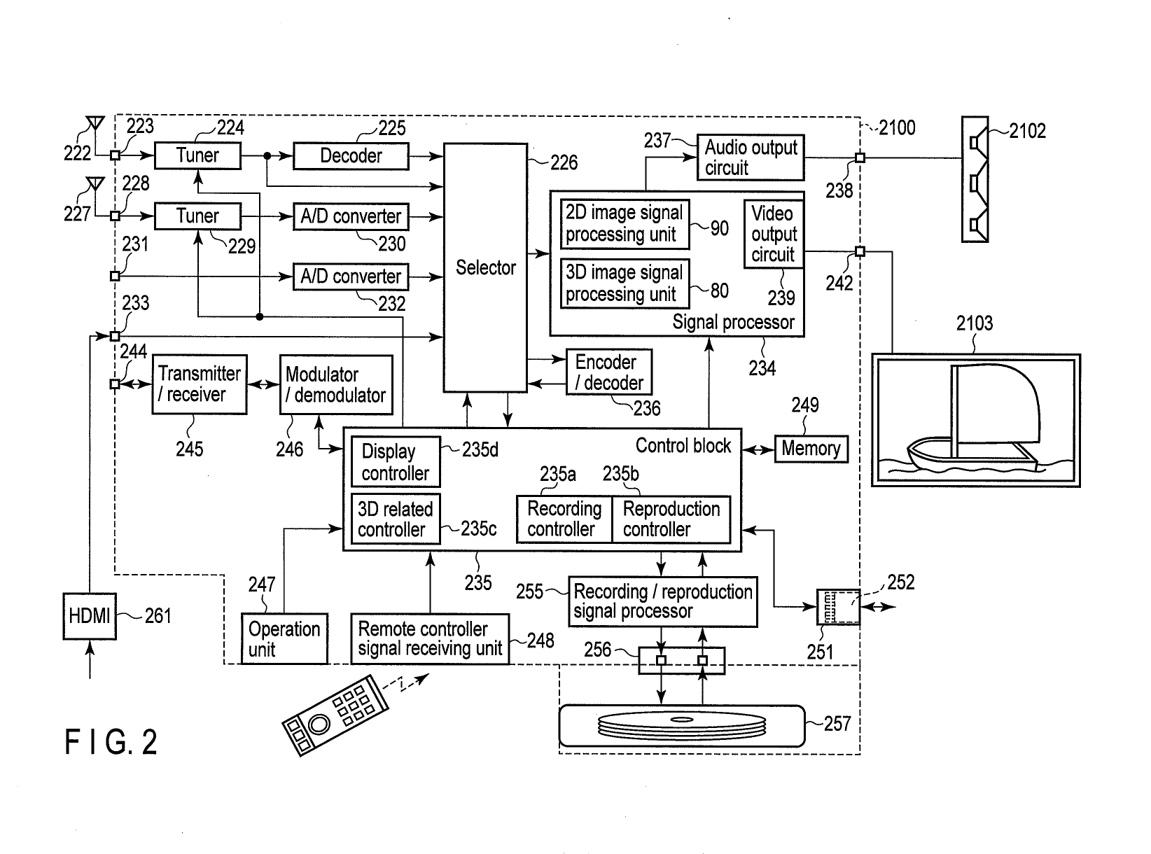

FIG. 2 schematically shows a signal processing system of a television (TV) broadcast receiving apparatus 2100, which is an example of an apparatus to which the embodiment is applied. A digital TV broadcasting signal received by an antenna 222 for receiving digital TV broadcasting is supplied to a tuner 224 via an input terminal 223. The tuner 224 tunes in to and demodulates a signal of the desired channel from the input digital TV broadcasting signal. A signal output from the tuner 224 is supplied to a decoder 225 where decode processing according to, for example, the MPEG (moving picture experts group) 2 method is performed before being supplied to a selector 226.

Output from the tuner 224 is also supplied to the selector 226 directly. Video/audio information (ex, a transport stream ST) is separated by the selector 226 so that the video/audio information can be processed by a recording/reproduction signal processor 255 via a control block 235. A signal processed by the recording/reproduction signal processor 255 can be recorded in a hard disk drive (HDD) 257. The HDD 257 is connected as a unit to the recording/reproduction signal processor 255 via a terminal 256 and can be replaced. The HDD 257 contains a recorder and a reader of a signal.

An analog TV broadcasting signal received by an antenna 227 for analog TV broadcasting is supplied to a tuner 229 via an input terminal 228. The tuner 229 tunes in to and demodulates a signal of the desired channel from the input analog TV broadcasting signal. Then, a signal output from the tuner 229 is digitized by an A/D (analog/digital) converter 230 before being output to the selector 226.

Analog video and audio signals supplied to an input terminal 231 for an analog signal to which, for example, devices such as a VTR are connected are supplied to an A/D converter 232 for digitalization and then output to the selector 226. Further, digital video and audio signals supplied to an input terminal 233 for a digital signal connected to an external device such as an optical disk or magnetic recording medium reproduction apparatus via, for example, HDMI (High Definition Multimedia Interface) 261 are supplied to the selector 226 unchanged.

When an A/D converted signal is recorded in the HDD 257, compression processing based on a predetermined format, for example, the MPEG (moving picture experts group) 2 method is performed on the A/D converted signal by an encoder in an encoder/decoder 236 accompanying the selector 226 before the A/D converted signal is recorded in the HDD 257 via the recording/reproduction signal processor 255. When the recording/reproduction signal processor 255 records information in the HDD 257 in cooperation with a recording controller 235a, for example, what kind of information to record in which directory of the HDD 257 is pre-programmed. Thus, conditions when a stream file is stored in a stream directory and conditions when identification information is stored in a recording list file are set.

The selector 226 selects one pair from four types of input digital video and audio signals to supply the pair to a signal processor 234.

The signal processor 234 includes a 3D image signal processing unit 80, a 2D image signal processing unit 90 and a video output unit 239. The 3D image signal processing unit 80 and the 2D image signal processing unit 90, respectively, separate audio information and video information from the input digital video signal and performs predetermined signal processing thereon. Audio decoding, tone adjustment, mix processing and the like are arbitrarily performed as the signal processing on the audio information. Color/brightness separation processing, color adjustment processing, image quality adjustment processing and the like are performed on the video information.

A video output unit 239 switches to 3D image signal output or 2D image signal output in accordance with 3D/2D switching. The video output unit 239 may include a synthesis unit that multiplexes graphic video, video of characters, figures, symbols and the like, user interface video, video of a program guide and the like from the control block 235 onto main video. The video output unit 239 may contain a scanning line number conversion.

Audio information is converted into an analog form by an audio output circuit 237 and the volume, channel balance and the like thereof are adjusted before being output to a speaker apparatus 2102 via an output terminal 238.

Video information undergoes synthesis processing of pixels, the scanning line number conversion and the like in the video output unit 239 before being output to a display apparatus 2103 via an output terminal 242.

Various kinds of operations including various receiving operations of the TV set 2100 are controlled by the control block 235 in a unified manner. The control block 235 is a set of microprocessors incorporating CPUs (central processing units). The control block 235 controls each of various blocks so that operation information from an operation unit 247 or operation information transmitted from a remote controller 2104 is acquired by a remote controller signal receiving unit 248 whereby operation content thereof is reflected.

The control block 235 uses a memory 249. The memory 249 mainly includes a ROM (read only memory) storing a control program executed by a CPU thereof, a RAM (random access memory) to provide a work area to the CPU, a nonvolatile memory in which various kinds of setting information and control information are stored.

The apparatus can perform communication with an external server via the Internet. A downstream signal from a connection terminal 244 is demodulated by transmitter/receiver 245 and demodulated by a modulator/demodulator 246 before being input into the control block 235. An upstream signal is modulated by the modulator/demodulator 246 and converted into a transmission signal by the transmitter/receiver 245 before being output to the connection terminal 244.

The control block 235 can perform conversion processing on dynamic images or service information downloaded from an external server to supply the converted images or information to the video output unit 239. The control block 235 can also transmit a service request signal to an external server in response to a remote controller operation.

Further, the control block 235 can read data in a card type memory 252 mounted on a connector 251. Thus, the present apparatus can read, for example, photo image data from the card type memory 252 to display the photo image data in the display apparatus 2103. When special color adjustments are made, image data from the card type memory 252 can be used as standard data or reference data.

In the above apparatus, a user views a desired program of a digital TV broadcasting signal and also selects a program by operating the remote controller 2104 to control the tuner 224 if the user wants to save the program in the HDD 257.

Output of the tuner 224 is decoded by the decoder 225 into a base-band video signal and the base-band video signal is input into the signal processor 234 from the selector 226. Accordingly, the user can view the desired program in the display apparatus 2103.

A stream (including many packets) of the selected program is input into the control block 235 via the selector 226. If the user performs a recording operation, the recording controller 235a selects the stream of the program and supplies the stream to the recording/reproduction signal processor 255. For example, a file number is attached to the stream of the selected program and the stream is stored in a file directory of the HDD 257 as a stream file by the operations of the recording controller 235a and the recording/reproduction signal processor 255.

If the user wants to reproduce and view the stream file recorded in the HDD 257, the user operates, for example, the remote controller 2104 to specify the display of, for example, a recording list file.

The recording list file has a table of a file number and a file name (called identification information) indicating what kinds of stream files are recorded in the HDD 257. If the user specifies the display of the recording list file, a recording list is displayed as a menu and the user moves the cursor to a desired program name or file number in the displayed list before operating the Decision button. Then, the reproduction of the desired stream file is started.

The specified stream file is read from the HDD 257 under the control of a reproduction controller 235b and decoded by the recording/reproduction signal processor 255 before being input into the signal processor 234 via the control block 235 and the selector 226.

The control block 235 includes a recording controller 235a, a reproduction controller 235b, a 3D related controller 235c and a display controller 235d.

The display controller 235d processes, for example, channel number data, message data, program table data and sub-picture data etc., and supplies these data to the video output unit 239.

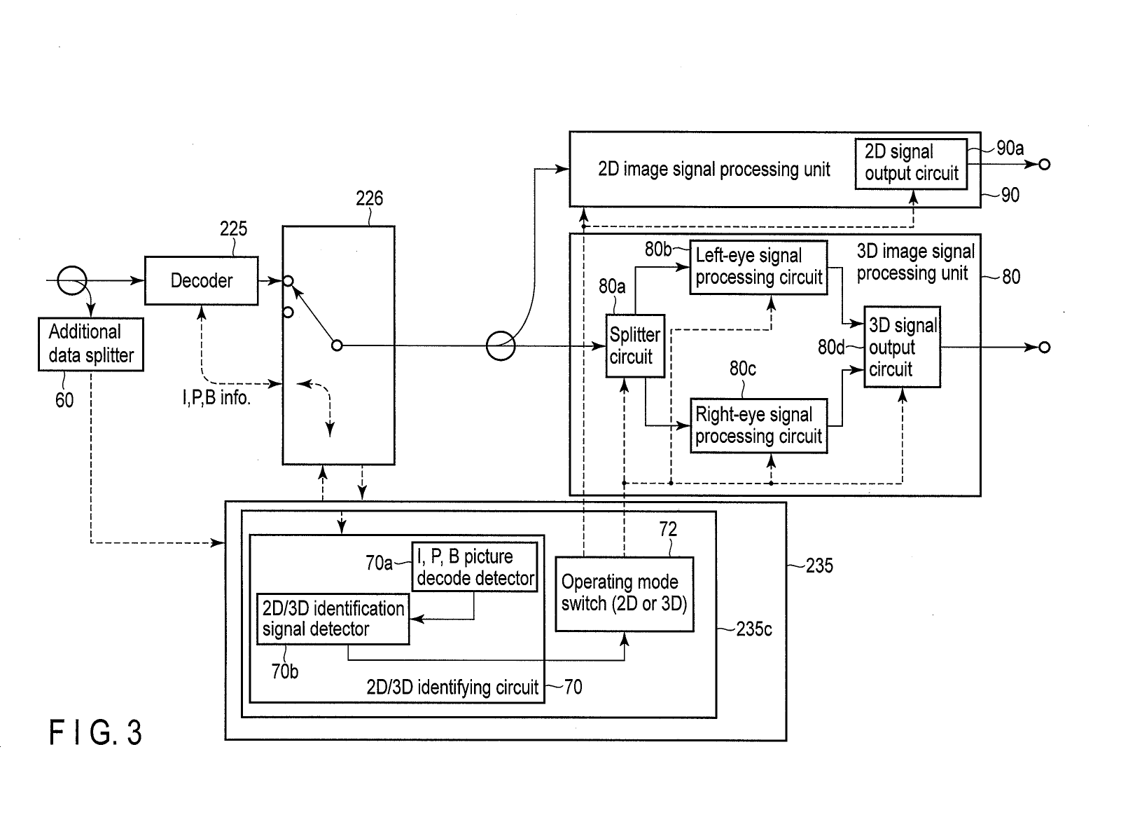

The configurations of the 3D related controller 235c, 3D image signal processing unit 80 and 2D image signal processing unit 90 will be described with reference to FIG. 3. A digital encoded image signal is input to the decoder 225. The digital encoded image signal contains additional data, which will be used in order to decode the encoded image signal. The additional data is extracted by an additional data splitter 60 and taken into the control block 235. The additional data splitter 60 may be provided either in the decoder 225 or in the selector 226.

The additional data is composed of various control data items contained in the sequence layer, picture layer, etc. of, for example, Moving Picture Expert Group (MPEG) 2 coded data. The additional data further may contain the macro block data of I, P and B pictures and other extension data. In information such as MPEG4 or Advanced Video Coding (AVC), Supplemental Enhancement Information (SEI) falls within this category of control data. Therefore, the additional data can contain identification data showing whether the encoded image signal is a 3D signal or a 2D signal, too. Further, the additional data can contain identification data that shows whether the frame of the picture layer is an I picture, P picture or B picture.

The decoder 225 decodes the encoded image signal in accordance with the additional data, and outputs a decoded image signal. The decoded image signal is supplied via the selector 226 to the signal processor 234. In the signal processor 234, the decoded image signal is processed in the 2D image signal processing unit 90 or the 3D image signal processing unit 80.

The additional data output from the additional data splitter 60 is input to a 2D/3D identifying circuit 70 provided in the 3D related controller 235c. The 2D/3D identifying circuit 70 has a picture decode detector 70a configured to detect whether the decoder 225 has decoded a specific picture frame (e.g., I picture) of the encoded image signal. The picture decode detector 70a receives I, P and B data information from the decoder 225, and monitors how the decoder 225 is decoding I, P and B picture frames. The picture decode detector 70a can therefore detect that a specific picture frame (e.g., I picture) has been decoded.

The 2D/3D identifying circuit 70 further has a 2D/3D identification signal detector 70b. Although named “2D/3D identification signal detector,” the detector 70b may be a detector that detects 3D identification signals only.

A 3D notification flag is contained as additional data in, for example, the picture layer. Note that in information such as MPEG4 or Advanced Video Coding (AVC), the supplemental enhancement information (SEI) contains a 3D notification flag as additional data. The 2D/3D identification signal detector 70b can therefore analyze the content of the additional data, thereby to detect whether the encoded image signal decoded in the decoder 225 is a 3D signal or a 2D signal.

In response to a signal coming from the picture decode detector 70a and indicating that the I picture frame has been decoded, the 2D/3D identification signal detector 70b supplies a signal representing the result of this detection to a signal processing mode switch 73. As a result, the signal processing is appropriately switched from the 2D image signal processing unit 90 to the 3D image signal processing unit 80, or vice versa.

In the 3D image signal processing unit 80, a splitter circuit 80a splits the decoded image signal into a signal of the left eye video and a signal of the right eye video. The signal of the left eye video and the signal of the right eye video are adjusted in contrast and color in a left-eye signal processing circuit 80b and a right-eye signal processing circuit 80c, respectively. The signals so processed are input to a 3D signal output circuit 80d. The 3D signal output circuit 80d outputs the signals so that the signal of the left eye video (L) and the signal of the right eye video (R) may be alternately displayed for each frame upon display, or displayed as the left and right halves of each frame, respectively, thereby to display a stereoscopic image.

In the image signal processing mode switching apparatus configured as shown in FIG. 3, the operating mode of the signal processing unit 80 is switched to the 3D image signal processing mode or the 2D image signal processing mode every time an I picture frame is input (or every time an I picture frame is decoded a plurality of times).

In order to minimize the noise made at the time of switching the operating mode, it suffices to determine whether a 3D image signal or a 2D image signal is decoded for each of I, P and B pictures. If the decision is made for each picture frame, however, the load on the control block 235 will increase. In view of this, whether a 3D image signal or a 2D image signal is decoded for each I picture (or several I pictures) is determined. The load on the control block 235 can thereby be greatly reduced. Noise may be displayed at the time of switching the operating mode. The disturbance of the image can, nonetheless, be concealed by supplying a mute control signal to the 3D signal output circuit 80d and a 2D signal output circuit 90a. Moreover, the image muting time can be suppressed to, for example, 1- to 5-GOP period, whereby the mode switching can be achieved without making the image appear strange.

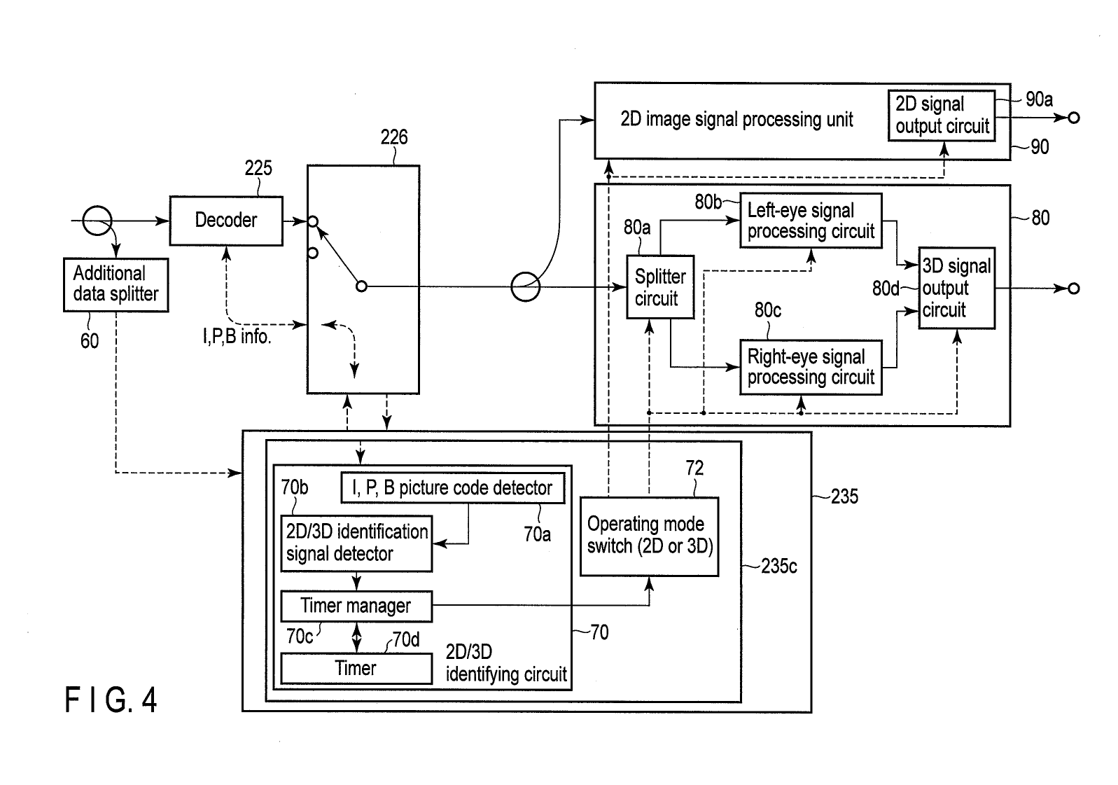

FIG. 4 shows another representative basic configuration for the image signal processing mode switching apparatus. The embodiment of FIG. 4 differs from the configuration of FIG. 3 in that a timing signal output from the 2D/3D identification signal detector 70b, for detecting, for example, a 3D signal, is input to a timer manager 70c. The timer manager 70c refers to the clock signal of a timer 70d.

In this embodiment, if the 2D/3D identification signal detector 70b receives a detection signal showing that a 3D image signal has been detected, the timer manager 70c resets the timer 70d. After resetting the timer 70d, the timer manager 70c monitors the clock signal of the timer 70d. When a prescribed time has elapsed (time over), the timer manager 70c gives a control signal to an operating mode switch 72. In response to the control signal, the operating mode switch 72 sets the operating mode of the signal processor 234 to the operating mode of the 2D image signal processing unit 90. That is, the 2D image signal processing unit 90 starts operating, in place of the signal processing unit 80.

The embodiment of FIG. 4 has the same advantage as the embodiment of FIG. 3, i.e., reduction of the load on the control block 235, achieved by determining whether a 3D signal or a 2D signal has been decoded for each I picture frame (or for a plurality of I picture frames). In addition, the embodiment of FIG. 4 is advantageous in that the 2D/3D identification signal detector 70b needs to detect a 3D image signal only. Hence, the embodiment is useful in the case where the broadcast signal does not carry a 2D identification signal, and carries only a 3D identification signal. The embodiment is also useful if a content already encoded and a new 3D encoded content are transmitted on the same stream.

As described above, it is determined whether a 3D or 2D image signal has been decoded for each I picture frame. Instead, it may be determined whether a 3D or 2D image signal has been decoded when an I picture frame is decoded a plurality of times.

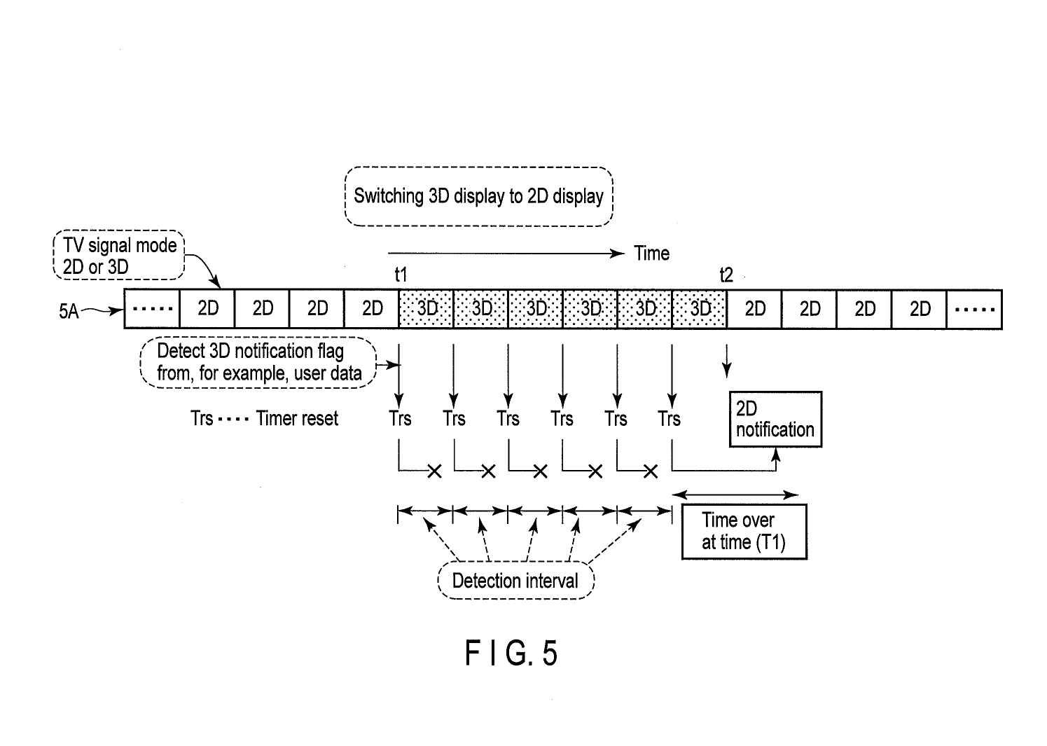

FIG. 5 is a timing chart showing how the apparatus according to this embodiment operates to switch the 3D image signal processing mode to the 2D image signal processing mode. FIG. 5 shows a mixed decoded image signal composed of a 2D image signal and a 3D image signal. The 2D image signal lasts until time t1, at which it changes to a 3D image signal, and at time t2, the 3D image signal changes to a 2D image signal.

In FIG. 5, “Trs” indicates the time when an I picture frame is completely decoded, whereby the 3D identification signal is detected and the timer 70d is reset, which starts measuring time. In the case shown in FIG. 5, the 3D image signal is detected at time t1. Therefore, at time t1, the 2D image signal processing unit 90 stops operating and the 3D image signal processing unit 80 starts operating.

Then, the timer 70d starts measuring time. It may then be determined that the I picture frame has been decoded and that a 3D identification signal has been detected. In this case, the timer 70d is reset and starts measuring time from the initial count value. Hence, so long as the timer 70d is reset within a given period, the timer manager 70c would not output a mode switching control signal.

The 3D identification signal may not be detected at time t2 when the I picture frame is completely decoded. In this case, the count value of the timer 70d assumes a time-over state. At this point, the timer manager 70c outputs a mode switching control signal to the operating mode switch 72. The operating mode switch 72 turns off the 3D image signal processing unit 80 and turns on the 2D image signal processing unit 90.

The period between time T1 and time T2 (i.e., time-over point) is longer than at least the period (detection interval) within which the 3D identification signal is detected.

In this embodiment, the 3D identification signal is not detected at time t2. If the 3D identification signal is detected at time t2, the operating mode may be immediately switched to the 2D image signal processing mode.

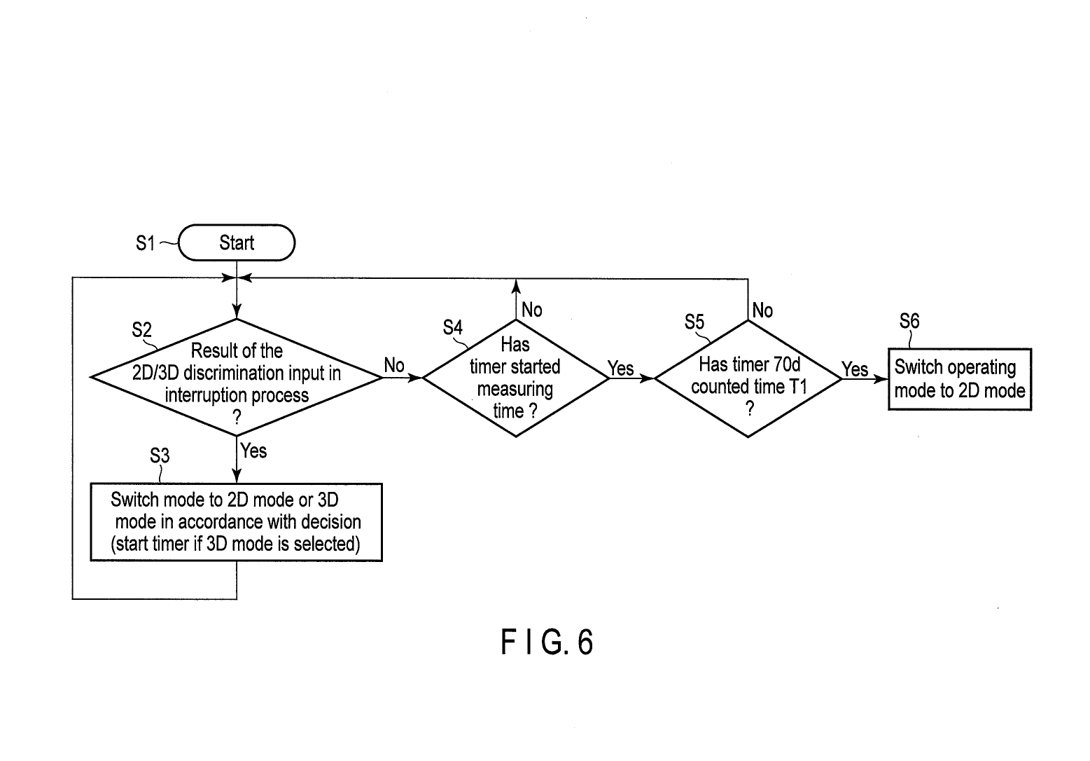

FIG. 6 is a flowchart showing how the apparatus operates at such timing as shown in FIG. 5. Upon the elapse of a prescribed interval, the apparatus starts operating and it is determined whether the result of the 2D/3D discrimination has been input in an interruption process (Step S2). If the result shows the decoding of a 3D image signal, the timer 70d is made to start measuring time again from the initial count value (Step S3). If the result does not show the decoding of a 3D image signal, it is determined whether the timer 70d has started measuring time (Step S4). If the timer has started measuring time, it is determined whether the timer 70d has counted time T1 (Step S5). If the timer 70d has counted time T1 (time over), the operating mode of the signal processor 234 is switched to the 2D image signal processing mode (Step S6).

How the operating mode of the signal processor 234 is switched from the 3D image signal processing mode to the 2D image signal processing mode has been explained with reference to FIG. 5 and FIG. 6.

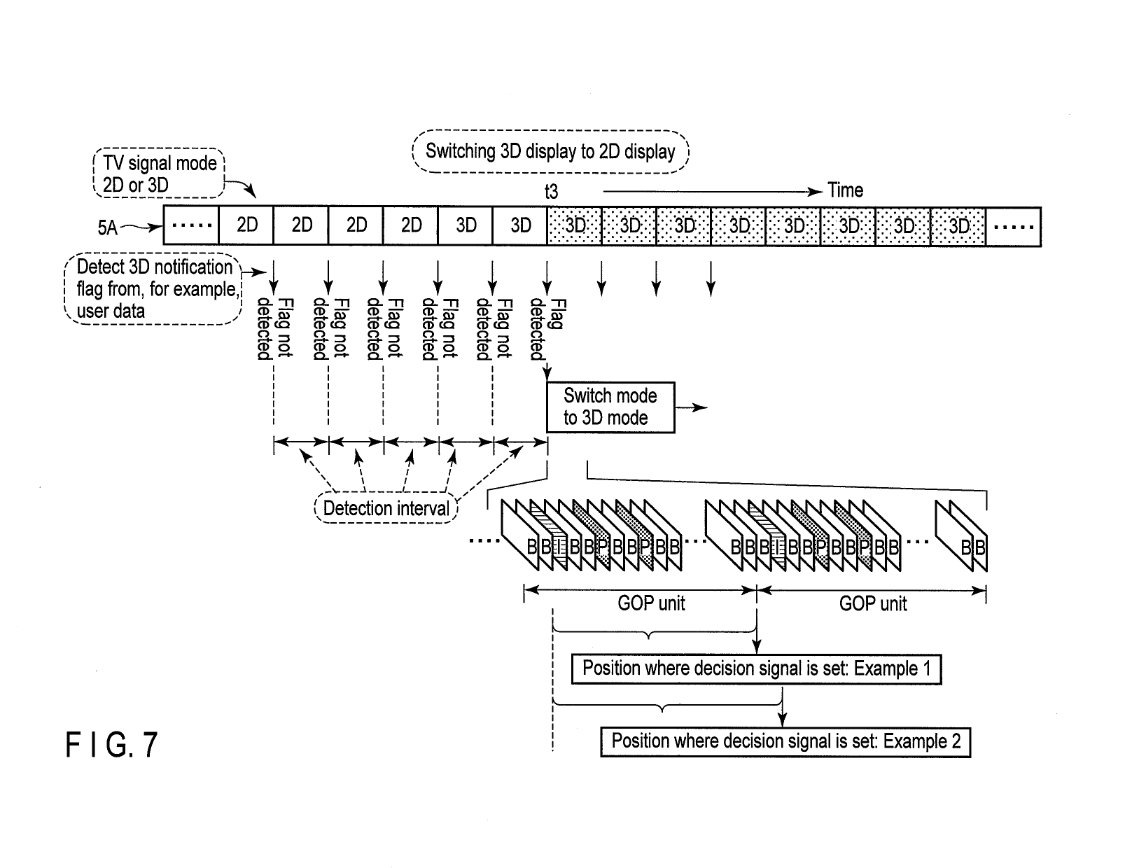

FIG. 7 shows how the apparatus according to the embodiment operates to switch the 2D image signal processing mode to the 3D image signal processing mode. 2D image signals are processed until time t3. At time t3, the processing of 3D image signals starts. At prescribed intervals, whether a 3D identification signal has been detected is determined repeatedly, each time when an I picture frame is completely decoded, or each time synchronized with an I picture frame being completely decoded.

Since the signal changes at time t3 to a 3D image signal, the 2D/3D identification signal detector 70b detects the 3D identification signal. Therefore, the timer manager 70c sets a prescribed mute period, and immediately switches the signal processor 234 to the 3D image signal processing mode. The 2D/3D identification signal detector 70b determines whether the picture frames (i.e., I, P and B pictures) pertain to a 3D image or a 2D image. This decision can be made by monitoring the information of the picture frames the decoder 225 has decoded. For example, the control block 235 analyzes the additional data (header information) of, for example, the picture layer, determining the order in which to decode the picture frames in the decoder 225. At this point, the identification signal showing whether the picture frames pertain to a 3D image or a 2D image is acquired from the additional data.

The time 70d and the timer manager 70c cooperate, setting a GOP period beginning at time t3. During the GOP period, the 2D/3D identification signal is discriminated in respect to the I, P and B picture frames. If the 3D identification signal has a value equal to or greater than N, the stream is determined to have switched to a 3D image signal, and the mode setting signal is set to 3D. If the 3D identification signal has a value smaller than N, the decision that the mode setting signal is set to 3D is found erroneous. In this case, the initial mode setting signal is set back to 2D. After time t3, a plurality of GOP periods may last (totaling, for example, about 1 second). During these GOP periods, the output of any image signal should be muted. When the image signal changes from a 2D signal to a 3D signal, the signal processor 234 may be switched to the 3D image signal processing mode at once.

The broadcasting apparatus may switch the image signal from a 2D image signal to a 3D image signal so that the 3D signal may be transmitted in the form of a stream. In this case, the encoder incorporated in the broadcasting apparatus encodes and compresses both the 2D image signal and the 3D image signal, one after the other. That is, adjacent 2D image picture frame and 3D image picture frame are encoded in series. As a result, two 2D picture frames (e.g., P and B picture frames) may be arranged before and after the I picture frame of the 3D image signal, respectively. If a 2D/3D identification signal is extracted from the picture layer of such a picture frame stream, a 2D identification signal may be detected after a 3D identification signal has been detected, though the stream has been switched to a 3D image signal. In this case, the image displayed is distorted if the signal processing mode is switched every time the identification signal is switched.

In the present embodiment, when a 3D identification signal is detected, the signal processing mode is immediately switched to the 3D image signal processing mode, and the 2D/3D identification signal is discriminated for each picture frame (I, P or B picture frame). If the number of 3D identification signals is equal to or greater than N, the stream is found to have been switched to a 3D image signal, and the mode setting signal is accordingly set to 3D. Alternatively, any 2D identification signal may be neglected for a prescribed period, and the mode setting signal may be set to 3D when a 3D identification signal arrives after that prescribed period.

The embodiment described above can switch the signal processing mode, both automatically and smoothly, in accordance with the state of receiving a 2D/3D mixed broadcast signal. Therefore, in the embodiment, no excessive load is imposed on the control block of the receiving apparatus, and the signal processing mode can be appropriately switched as fast as possible. As a result, errors are prevented in switching the signal processing mode, and the noise made at the display unit is reduced at the time of switching the image signal processing mode.

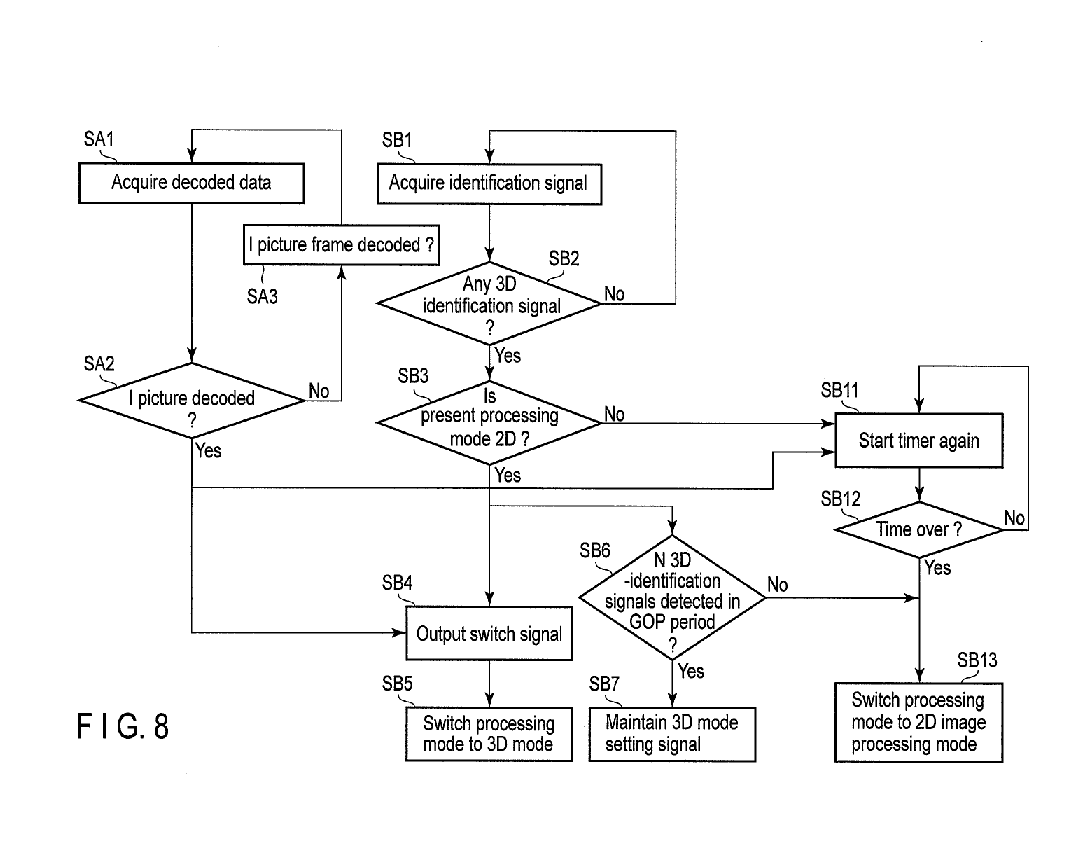

FIG. 8 is a flowchart showing another manner in which the apparatus according to the embodiment may operate. In the loop composed of Steps SA1, SA2 and SA3, it is detected which picture frame is decoded by the decoder 225; an I picture frame, P picture frame or B picture frame. In Step SA3, intervals are set for the detection points. In Step SA1, the data decoded is acquired. In Step SA3, it is determined whether the I picture frame has been decoded.

In a loop composed of Steps SB1 and SB2, the identification signal of the picture frame being decoded is acquired (Step SB1), and it is determined whether the identification signal acquired is a 3D identification signal or not (Step SB2). If the identification signal is a 3D identification signal, it is determined in Step SB3 whether the present processing mode is the 2D image signal processing mode.

If the present processing mode is found to be the 2D image signal processing mode in Step SB3, the signal processing mode is switched to the 3D image processing mode when the I picture frame is completely decoded, in Steps SB4 and SB5. Whether an N number of 3D identification signals have been detected in the GOP period is determined (Step SB6), as explained with reference to FIG. 7. If an N number of 3D identification signals have been detected, the 3D mode setting signal is maintained (Step SB7). If an N number of 3D identification signals have not been detected, the signal processing mode is switched to the 2D image signal processing mode (SB13).

If a 3D identification signal is detected in Step SB2 and the present processing mode is therefore the 3D image signal processing mode, the timer is reset (Step SB11). That is, the operation goes to the state of FIG. 5. If the timer assumes a time-over state (YES in Step SB12), the signal processing mode is switched to the 2D image processing mode (Step SB13).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image signal processing mode switching apparatus comprising:
a decoder configured to output a decoded image signal by decoding an encoded image signal in accordance with additional data;
a signal processor configured to process the decoded image signal in a 2D image signal processing mode or a 3D image signal processing mode;
a first detector configured to detect whether a specific frame of the encoded image signal has been decoded; and
a second detector configured to analyze the additional data to detect whether the encoded image signal relates to 2D or 3D data,
wherein the second detector is further configured to output, when the first detector detects that the specific frame has been decoded, a result of detection to a signal processing mode switch provided in the signal processor.

2. The image signal processing mode switching apparatus of claim 1, further having a timer manager configured to receive the result of detection performed by the second detector and to give a processing mode switching control signal to the switch if the result of detection is not input to the timer manager within a prescribed time.

3. The image signal processing mode switching apparatus of claim 2, further having a timer, wherein the timer manager is further configured to reset the timer in response to receiving the result of detection performed by the second detector, and to give the processing mode switching control signal to the switch if the result of detection is not received within a prescribed time.

4. The image signal processing mode switching apparatus of claim 3, wherein the first detector is configured to detect that an I frame has been decoded.

5. The image signal processing mode switching apparatus of claim 4, wherein the first detector is configured to allow the second detector to output the result of detection when a plurality of I frames are completely decoded.

6. The image signal processing mode switching apparatus of claim 3, wherein the signal processor has an output circuit, and the switch is configured to give the output circuit a mute control signal for temporarily muting the image signal upon receiving the processing mode switching control signal.

7. An image signal processing mode switching method in which an encoded image signal is decoded in accordance with additional data, the method comprising:
detecting whether a specific frame of the encoded image signal has been decoded;
analyzing the additional data to detect whether the encoded image signal pertains to 2D or 3D and obtaining a result of detection;
measuring a period of time for decoding the specific frame, said period starting when the result of said detection is obtained and ending when a following result of detection is obtained; and
giving a processing mode switching control signal to a switch if said following result of detection is not obtained within a prescribed period of time.
